(19) United States
(12) Patent Application Publication
(10) Pub. No.: US 2026/0317923 A1
(43) Pub. Date: Oct. 15, 2026

(54) PHOTOELECTROCATALYST FOR WATER SPLITTING

(71) Applicant: KING FAHD UNIVERSITY OF PETROLEUM AND MINERALS, Dhahran (SA)

(72) Inventors: Masoud AL-RASHEIDI, Dhahran (SA); Firoz KHAN, Dhahran (SA); Abuzar KHAN, Dhahran (SA)

(73) Assignee: KING FAHD UNIVERSITY OF PETROLEUM AND MINERALS, Dhahran (SA)

(21) Appl. No.: 19/179,873

(22) Filed: Apr. 15, 2025

(30) Foreign Application Priority Data
Apr. 9, 2025 (SA) 1020252253

(51) Int. Cl. C25B 11/049; C25B 1/04; C25B 11/037; C25B 11/047

(52) U.S. Cl. CPC C25B 11/049; C25B 1/04; C25B 11/037; C25B 11/047

(57) ABSTRACT

A photoelectrocatalyst that includes nanoparticles of manganese (Mn) and cobalt (Co) co-doped zinc oxide (ZnO) having a formula of MnₓCo_{y}Zn_{1-x-y}O, where 0<x≤0.015 and 0<y≤0.025. The nanoparticles have a band gap of 3.50 electron volts (eV) to 3.75 eV. The photoelectrocatalyst is used in method of producing hydrogen gas by a hydrogen evolution reaction (HER) in an aqueous solution. The photoelectrocatalyst is also used in a method of producing oxygen gas by an oxygen evolution reaction (OER) in an aqueous solution.

### CROSS-REFERENCE TO RELATED APPLICATION

The present disclosure claims the benefit of Saudi patent application Ser. No. 1020252253, filed on Apr. 9, 2025 with the Saudi Authority for Intellectual Property Office, which is incorporated herein by reference in its entirety.

### STATEMENT OF ACKNOWLEDGEMENT

The authors would like to acknowledge the support provided by the IRC-REPS at King Fahd University of Petroleum & Minerals (KFUPM), Dhahran, Saudi Arabia, under Grant No. INRE2308 for this work.

### BACKGROUND

### Technical Field

The present disclosure is directed towards a method of water splitting utilizing a manganese and cobalt co-doped photoelectrocatalyst.

### Description of Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly nor impliedly admitted as prior art against the present invention.

The global energy landscape is undergoing an overwhelming transformation driven by the pressing needs to mitigate climate change and achieve sustainable energy production. The reliance on fossil fuel, which has been the primary energy source for decades, has led to severe environmental consequences, including air pollution, greenhouse gas emissions, and ecological degradation. Addressing these challenges requires a strategic shift towards clean and renewable energy sources that may meet the ever-increasing energy demands while minimizing the environmental impact. In this context, hydrogen (H₂) has emerged as a desirable alternative energy carrier due to its high energy density, zero carbon emissions during its utilization, and versatility in applications ranging from transportation to power generation [Zhang L., et. al., A comprehensive review of the promising clean energy carrier: Hydrogen production, transportation, storage, and utilization (HPTSU) technologies, Fuel, 2024, 355, 129455]

Photoelectrochemical (PEC) water splitting, a process that utilizes solar energy to dissociate water molecules into hydrogen and oxygen, has gained significant traction as a clean and renewable approach for hydrogen production [Yu J. M., et. al., High-performance and stable photoelectrochemical water splitting cell with organic-photoactive-layer-based photoanode, Nature Communications, 2020, 11, 1-9]. PEC water splitting uses abundant solar energy to drive the water-splitting reaction, potentially offering a sustainable solution for generating hydrogen fuel without contributing to greenhouse gas emissions [Miller, E. L., Photoelectrochemical water splitting, Qureshi F, Tahir M. Photoelectrochemical water splitting with engineering aspects for hydrogen production, Recent advances, strategies and challenges, Energy Environ. Sci., 2015, 8, 2809-10]. However, the widespread implementation of PEC water splitting hinges on the development of efficient and cost-effective photocatalysts, ideally which are capable of absorbing a broad range of the solar spectrum and facilitating the required redox reactions [Sohail, M. et. al., Recent developments, advances and strategies in heterogeneous photocatalysts for water splitting, Nanoscale Adv, 2024, 6, 1286-330].

Among the various photocatalyst materials explored, zinc oxide (ZnO) and subsequent doped variants are considered desirable due to structural, optical, and electronic properties of ZnO and doped variants [Samadi, M., et. al., Recent progress on doped ZnO nanostructures for visible-light photocatalysis, Thin Solid Films, 2016, 605, 2-19; & Kumar, S., et. al., Nanoscale zinc oxide based heterojunctions as visible light active photocatalysts for hydrogen energy and environmental remediation, Catalysis Reviews, 2020, 62, 346-405]. ZnO is a wide-bandgap (3.2 eV) semiconductor with high light absorption capabilities, making it a candidate for photocatalytic applications [Kumar, N., et. al., Photocatalysis by zinc oxide-based nanomaterials, Nanostructured Zinc Oxide: Synthesis, Properties and Applications, 2021, 393-457]. However, pristine ZnO material often suffers from rapid recombination of photogenerated electron-hole pairs, limiting overall photocatalytic efficiency of ZnO [Kumar, S. G. and Rao, K. S. R. K., Zinc oxide based photocatalysis: tailoring surface-bulk structure and related interfacial charge carrier dynamics for better environmental applications, RSC Adv., 2014, 5, 3306-51]. To overcome this limitation, various strategies, including metal and nonmetal doping and co-doping of ZnO, formation of heterostructures surface modification, have been explored [Banerjee, S., et. al., Dopant inculcated ZnO based photoelectrodes for revitalizing photoelectrochemical water splitting, Mater. Chem. Phys., 2022, 277, 125548; Alam, U., et. al., Highly efficient Y and V co-doped ZnO photocatalyst with enhanced dye sensitized visible light photocatalytic activity, Catal. Today, 2017, 284, 169-78; Khan, A., et. al., A novel fabrication methodology for sulfur-doped ZnO nanorods as an active photoanode for improved water oxidation in visible-light regime, Nanotechnology, 2016, 28, 055602; Liccardo, L., et. al., Nanoscale ZnO/α-Fe₂O₃ Heterostructures: Toward Efficient and Low-Cost Photoanodes for Water Splitting, Small Science 2022, 2, 2100104; & Choubey, P., et. al., Surface Modifications of a vertically grown nanostructure for Boosting photoelectrochemical water-splitting performance, ACS Applied Nano Materials, 2024, 7, 23, 26300-26321].

Transition metal doping of ZnO has been reported as a strategy to overcome the limitations of ZnO as a photocatalyst or in photoelectrochemical (PEC) water splitting. Co-doping of photocatalysts with multiple elements has emerged as a promising approach. Co-doping may synergistically combine the benefits of individual dopants, resulting in further improvements in structural, optoelectronic, and photocatalytic properties. However, there is still a requirement for highly efficient and sustainable photoelectrocatalyst, hence, there is an unaddressed gap in photoelectrochemical energy production.

Accordingly, one object of the present disclosure is to provide a method of synthesizing a co-doped photocatalyst for water splitting that may circumvent the drawbacks, such as, economical limitations, environmental limitations, and poor reusability, of methods and materials known in the art.

### SUMMARY

According to a first aspect, the present disclosure relates to a photoelectrocatalyst. In some embodiments, the photoelectrocatalyst includes nanoparticles of manganese (Mn) and cobalt (Co) co-doped zinc oxide (ZnO) having a formula of MnₓCo_{y}Zn_{1-x-y}O, where 0<x≤0.015 and 0<y≤0.025. In some embodiments, the nanoparticles have a band gap of 3.50 electron volts (eV) to 3.75 eV.

In some embodiments, the nanoparticles have a crystalline wurtzite structure examined by powder X-ray diffraction (PXRD).

In some embodiments, the nanoparticles have a mean crystallite size of 25 nanometers (nm) to 60 nm by PXRD.

In some embodiments, the nanoparticles have a flattened hexagonal disc shape having a mean width of 250 nm to 1750 nm and a mean thickness of 50 nm to 750 nm.

The present disclosure also relates to a method of forming the photoelectrocatalyst. In some embodiments, the method includes forming a manganese solution including a zinc source and a manganese source, forming a cobalt solution including the zinc source and a cobalt source, mixing the manganese solution and the cobalt solution to form a metal solution. In some embodiments, the method further includes, adding to the metal solution a base solution including a hydroxide base to form a reaction mixture, hydrothermally treating the reaction mixture at 160° C. to 200° C. for 1 to 8 hours to form an intermediate product, and annealing the intermediate product at 225° C. to 325° C. in air to form the photoelectrocatalyst.

In some embodiments, the zinc source is zinc acetate.

In some embodiments, the manganese source is manganese acetate.

In some embodiments, the cobalt source is cobalt nitrate.

In some embodiments, the hydroxide base is sodium hydroxide.

In some embodiments, the hydroxide base is present in the base solution at a concentration of 0.01 molar (M) to 0.5 M.

The present disclosure also relates to a method of producing hydrogen gas by a hydrogen evolution reaction (HER). In some embodiments, the method includes contacting the aforementioned photoelectrocatalyst with an aqueous electrolyte solution, applying a potential of −600 millivolts (mV) to −50 mV vs Ag/AgCl to the photoelectrocatalyst and a counter electrode immersed in the aqueous electrolyte solution. In some embodiments, the method further includes irradiating the photoelectrocatalyst with a light source having an intensity of 10 megawatts per square centimeter (mW/cm²) to 500 mW/cm², where the aqueous electrolyte solution includes sulfate anions.

In some embodiments, the aqueous electrolyte solution is an aqueous sodium sulfate solution having a sulfate anion concentration of 0.05 M to 1.0 M.

In some embodiments, the photoelectrocatalyst has a peak photocurrent density of 6 micro amperes per square centime (μA/cm²) to 20 μA/cm².

In some embodiments, the photoelectrocatalyst has a photocurrent density of 5 μA/cm² to 7.5 μA/cm² at an applied potential of −100 mV vs Ag/AgCl.

In some embodiments, the photoelectrocatalyst has a ratio of photocurrent density to current density without illumination of 2:1 to 3.5:1 at an applied potential of −300 mV vs Ag/AgCl.

The present disclosure also relates to a method of producing oxygen gas by an oxygen evolution reaction (OER). In some embodiments, the method includes contacting the photoelectrocatalyst with an aqueous electrolyte solution, applying a potential of 500 mV to 1100 mV vs Ag/AgCl to the photoelectrocatalyst and a counter electrode immersed in the aqueous electrolyte solution. In some embodiments, the method further includes irradiating the photoelectrocatalyst with a light source having an intensity of 10 mW/cm² to 500 mW/cm², where the aqueous electrolyte solution includes sulfate anions.

In some embodiments, the aqueous electrolyte solution is an aqueous sodium sulfate solution having a sulfate anion concentration of 0.05 M to 1.0 M.

In some embodiments, the photoelectrocatalyst has a peak photocurrent density of 1.25 μA/cm² to 4.0 μA/cm².

In some embodiments, the photoelectrocatalyst has a photocurrent density of 0.75 μA/cm² to 1.5 μA/cm² at an applied potential of 800 mV vs Ag/AgCl.

In some embodiments, the photoelectrocatalyst has a ratio of photocurrent density to current density without illumination of 1.5:1 to 4:1 at an applied potential of 800 mV vs Ag/AgCl.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flow chart depicting a method of forming a photoelectrocatalyst, according to certain embodiments.

FIG. 1B is a flow chart depicting a method of producing hydrogen gas by a hydrogen evolution reaction (HER), according to certain embodiments.

FIG. 1C is a flow chart depicting a method of producing oxygen gas by an oxygen evolution reaction (OER), according to certain embodiments.

FIG. 2A shows X-ray diffraction (XRD) patterns, in a 2-theta range of 20° to 70°, of Mn—Zn co-doped ZnO (MCZO) nanoparticles (NPs), depicting the crystalline quality of the MCZO NPs in the as-fabricated 0-MoO₃ nanocomposite, according to certain embodiments.

FIG. 2B shows Fourier transform infrared (FTIR) spectroscopy results of MCZO NPs, according to certain embodiments.

FIG. 3A is a field emission scanning electron microscopy (FESEM) image of MCZO NPs for Mn content at 0%, according to certain embodiments.

FIG. 3B is a FESEM image of MCZO NPs for Mn content at 0.8%, according to certain embodiments.

FIG. 4A shows a combined elemental map of MCZO NPs, obtained using energy dispersive spectroscopy (EDS), according to certain embodiments.

FIG. 4B is an EDS elemental map of MCZO NPs depicting the presence of zinc (Zn), according to certain embodiments.

FIG. 4C is an EDS elemental map of MCZO NPs depicting the presence of oxygen (O), according to certain embodiments.

FIG. 4D is an EDS elemental map of MCZO NPs depicting the presence of manganese (Mn), according to certain embodiments.

FIG. 4E is an EDS elemental map of MCZO NPs depicting the presence of cobalt (Co), according to certain embodiments.

FIG. 5A shows a transmission electron microscopy (TEM) image of MCZO NPs for Mn content at 0%, according to certain embodiments.

FIG. 5B shows TEM image of MCZO NPs for Mn content at 0.8%, according to certain embodiments.

FIG. 6A is a graph depicting an absorption coefficient of CZO and MCZO, according to certain embodiments.

FIG. 6B is a Tauc plot for the determination of bandgap of CZO and MCZO, according to certain embodiments.

FIG. 6C is a graph depicting photoluminescence spectra of CZO and MCZO, according to certain embodiments.

FIG. 7A show linear sweep voltammetry (LSV) plots of CZO and MCZO under dark and illuminated conditions, depicting photoelectrochemical performance of CZO and MCZO under oxygen evolution reaction (OER) condition in 0.5 M Na₂SO₄ electrolyte, according to certain embodiments.

FIG. 7B show chronoamperometric curves of CZO and MCZO with a 30 second ON/OFF cycle, depicting photoelectrochemical performance of CZO and MCZO under OER condition in 0.5 M Na₂SO₄ electrolyte, according to certain embodiments.

FIG. 7C show electrochemical impedance spectroscopy (EIS) results in form of Nyquist plots for CZO and MCZO, under dark and illuminated condition, depicting photoelectrochemical performance of CZO and MCZO under OER condition in 0.5 M Na₂SO₄ electrolyte, according to certain embodiments.

FIG. 7D shows stability curve of CZO and MCZO under illuminated conditions, depicting photoelectrochemical performance of CZO and MCZO under OER condition in 0.5 M Na₂SO₄ electrolyte, according to certain embodiments.

FIG. 8A show LSV plots of CZO and MCZO under dark and illuminated conditions, depicting photoelectrochemical performance of CZO and MCZO under hydrogen evolution reaction (HER) condition in 0.5 M Na₂SO₄ electrolyte, according to certain embodiments.

FIG. 8B show chronoamperometric curves of CZO and MCZO with a 30 second ON/OFF cycle, depicting photoelectrochemical performance of CZO and MCZO under HER condition in 0.5 M Na₂SO₄ electrolyte, according to certain embodiments.

FIG. 8C shows stability curve of CZO and MCZO under illuminated conditions, depicting photoelectrochemical performance of CZO and MCZO under HER condition in 0.5 M Na₂SO₄ electrolyte, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the term “photoelectrocatalyst” refers to a process in which a material, typically a semiconductor, facilitates both light-driven (photocatalytic) and electrical (electrocatalytic) reactions. A photoelectrocatalyst may absorb photons to generate electron-hole pairs, which then are available to participate in redox reactions, often in the presence of an applied external voltage. This process is used in various applications such as water splitting for hydrogen production and/or oxygen production, carbon dioxide reduction, and other energy conversion or environmental remediation processes.

As used herein, the term “mean crystallite size” refers to the average size of the individual crystalline domains or particles within a material, typically measured in nanometers (nm). It is determined by analyzing the diffraction patterns obtained from techniques such as X-ray diffraction (XRD or PXRD).

As used herein, the term “hydrogen evolution reaction” (HER) refers to a process in which hydrogen gas (H₂) is produced through the reduction of protons (H⁺) or water (H₂O) on the surface of a catalyst, typically under an applied electric potential. The reaction is typically carried out in aqueous solutions, often as part of electrochemical water splitting, where water molecules are split into hydrogen and oxygen gases. The HER is a useful reaction in renewable energy technologies, such as in electrolysis and photoelectrocatalysis, aimed at producing hydrogen as a clean energy carrier. The efficiency of the HER may depend on factors like the choice of catalyst, applied voltage, and reaction conditions.

As used herein, the term “aqueous electrolyte solution” refers to a solution in which an electrolyte (such as an acid, base, or salt) is dissolved in water to facilitate the conduction of ions. This solution is commonly used in electrochemical processes, including electrolysis, batteries, fuel cells, and corrosion studies, where the electrolyte provides a medium for ionic conductivity between the electrodes. The specific composition of the aqueous electrolyte can influence the efficiency of the electrochemical reactions by affecting the ion transport, pH, and the overall stability of the system. Examples of aqueous electrolyte solutions include sulfuric acid, sodium hydroxide, potassium chloride, and potassium hydroxide.

As used herein, the term “counter electrode” refers to an electrode in an electrochemical cell that serves as the site for the complementary half-reaction to the reaction occurring at the working electrode. The counter electrode typically completes the electrical circuit by allowing current to flow through the electrolyte without participating directly in the reaction of interest. It is often made of an inert material, such as platinum, graphite, or gold, to prevent unwanted side reactions. In processes like electrolysis or electrochemical reactions (e.g., hydrogen evolution or oxygen reduction), the counter electrode provides the necessary counterbalancing charge flow to maintain the overall charge balance in the system.

As used herein, the term “photocurrent density” refers to the amount of electric current generated per unit area of an electrode when exposed to light, typically in a photoelectrochemical system. It is a measure of the efficiency of a photo electrocatalytic material in converting light energy into electrical current. Photocurrent density is commonly expressed in units of milliamps per square centimeter (mA/cm²). The photocurrent is generated when photons are absorbed by a semiconductor material, leading to the generation of electron-hole pairs, which then contribute to a redox reaction at the electrode surface. Photocurrent density is an important parameter for evaluating the performance of materials used in applications such as solar cells, photoelectrochemical water splitting, and other light-driven electrochemical processes.

As used herein, the term “oxygen evolution reaction” (OER) refers to an electrochemical process in which oxygen gas (O₂) is produced by the oxidation of water (H₂O) or hydroxide ions (OH⁻) at the anode of an electrochemical cell. This reaction occurs under the application of an external electrical potential and is a critical step in water splitting, electrolysis, and other renewable energy technologies aimed at generating hydrogen. The OER typically involves the transfer of multiple electrons and protons, and it is known to be a kinetically challenging reaction due to the high overpotentials required for efficient oxygen production. The efficiency of the OER may be influenced by factors such as the choice of catalyst, electrode material, and applied voltage.

The present disclosure relates to a bifunctional photoelectrocatalyst that may be useful for hydrogen and oxygen gas production. The photoelectrocatalyst may offer a sustainable solution for renewable energy generation through water splitting. The photoelectrocatalyst may be useful for an increased ability to efficiently generate hydrogen and oxygen through a catalytic process, providing a clean, sustainable, and rapid solution for hydrogen and oxygen production.

According to a first aspect, the present disclosure relates to a photoelectrocatalyst. In some embodiments, the photoelectrocatalyst includes nanoparticles of Mn and Co co-doped ZnO having a formula of MnₓCo_{y}Zn_{1-x-y}O, where 0<x≤0.015 and 0<y≤0.025. In some embodiments, the value of x may range from greater than 0 to 0.015. For example, x may have a value of 0.001, 0.002, 0.003, 0.004, 0.005, 0.006, 0.007, 0.008, 0.009, 0.010, 0.011, 0.012, 0.013, 0.014, or 0.0015. In some embodiments, the value of y may range from greater than 0 to 0.025. For example, y may have a value of 0.001, 0.002, 0.003, 0.004, 0.005, 0.006, 0.007, 0.008, 0.009, 0.010, 0.011, 0.012, 0.013, 0.014, 0.015, 0.016, 0.017, 0.018, 0.019, 0.020, 0.021, 0.022, 0.023, 0.024, or 0.025.

In some embodiments, the nanoparticles have a band gap of from 3.50 to 3.75 eV. For example, the nanoparticles may have a bandgap of 3.50 eV, 3.55 eV, 3.60 eV, 3.65 eV, 3.70 eV, or 3.75 eV. In some embodiments, the nanoparticles have a band gap of 3.61 eV.

In some embodiments, the nanoparticles may exhibit a cubic zincblende crystal structure, a hexagonal wurtzite structure, or a mixture of these. In some embodiments, the nanoparticles have a crystalline wurtzite structure by X-ray diffraction (XRD).

In some embodiments, the nanoparticles exhibit a mean crystallite size ranging from 25 to 60 nm by XRD. For example, the nanoparticle may have a mean crystallite size of 25 nm, 27.5 nm, 30 nm, 32.5 nm, 35 nm, 37.5 nm, 40 nm, 42.5 nm, 45 nm, 47.5 nm, 50 nm, 52.5 nm, 55 nm, 57.5 nm, 60 nm, 62.5 nm, or 65 nm. In some embodiments, the nanoparticles have a mean crystallite size of 42.66 nm. In some embodiments, the nanoparticles have a mean crystallite size of 40.31 nm.

In general, the nanoparticles can be any shape known to one of ordinary skill in the art. Examples of suitable shapes the nanoparticles may take include spheres, spheroids, lentoids, ovoids, solid polyhedra such as tetrahedra, cubes, octahedra, icosahedra, dodecahedra, hollow polyhedra (also known as nanocages), stellated polyhedra (both regular and irregular, also known as nanostars), triangular prisms (also known as nanotriangles), hollow spherical shells (also known as nanoshells), tubes (also known as nanotubes), nanosheets, nanoplatelets, nanodisks, rods (also known as nanorods), belts (also known as nanobelts), ribbons (also known as nanoribbons), and mixtures thereof. In the case of nanorods, the rod shape may be defined by a ratio of a rod length to a rod width, the ratio being known as the aspect ratio. For nanoparticles of the current invention, nanorods should have an aspect ratio less than 1000, preferably less than 750, preferably less than 500, preferably less than 250, preferably less than 100, preferably less than 75, preferably less than 50, preferably less than 25.

In some embodiments, the nanoparticles have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of nanoparticles having a different shape. As used herein, the term “non-uniform shape” refers to an average consistent shape that differs by more than 10% of the distribution of nanoparticles having a different shape. In one embodiment, the shape is uniform and at least 90% of the nanoparticles are spherical or substantially circular, and less than 10% are polygonal. In another embodiment, the shape is non-uniform and less than 90% of the nanoparticles are spherical or substantially circular, and greater than 10% are polygonal.

In some embodiments, the nanocomposites have a flattened hexagonal disc shape morphology. In some embodiments, the flattened hexagonal disc shape has a mean width of from 250 to 1750 nm. For example, the flattened hexagonal disc shape may have a mean width of 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, 1550 nm, 1600 nm, 1650 nm, 1700 nm, or 1750 nm. In some embodiments, the flattened hexagonal disc shape morphology has a mean thickness of from 50 to 750 nm. For example, the flattened hexagonal disc shape may have a mean thickness of 50 nm, 75 nm, 100 nm, 125 nm, 150 nm, 175 nm, 200 nm, 225 nm, 250 nm, 275 nm, 300 nm, 325 nm, 350 nm, 375 nm, 400 nm, 425 nm, 450 nm, 475 nm, 500 nm, 525 nm, 550 nm, 575 nm, 600 nm, 625 nm, 650 nm, 675 nm, 700 nm, 725 nm, or 750 nm.

In some embodiments, the nanoparticles of the present disclosure are monodisperse, having a coefficient of variation or relative standard deviation, expressed as a percentage and defined as the ratio of the particle size standard deviation (o) to the particle size mean (u) multiplied by 100 of less than 25%, preferably less than 10%, preferably less than 8%, preferably less than 6%, preferably less than 5%, preferably less than 4%, preferably less than 3%, preferably less than 2%. In some embodiments, the nanoparticles of the present disclosure are monodisperse having a particle size distribution ranging from 80% of the average particle size to 120% of the average particle size, preferably 90-110%, preferably 95-105% of the average particle size. In some embodiments, the nanoparticles are not monodisperse.

In general, the particle size may be determined by any suitable method known to one of ordinary skill in the art. In some embodiments, the particle size is determined by powder X-ray diffraction (PXRD). Using PXRD, the particle size may be determined using the Scherrer equation, which relates the full-width at half-maximum (FWHM) of diffraction peaks to the size of regions comprised of a single crystalline domain (known as crystallites) in the sample. In some embodiments, the crystallite size is the same as the particle size. For accurate particle size measurement by PXRD, the particles should be crystalline, comprise only a single crystal, and lack non-crystalline portions. Typically, the crystallite size underestimates particle size compared to other measures due to factors such as amorphous regions of particles, the inclusion of non-crystalline material on the surface of particles such as bulky surface ligands, and particles which may be composed of multiple crystalline domains. In some embodiments, the particle size is determined by dynamic light scattering (DLS). DLS is a technique which uses the time-dependent fluctuations in light scattered by particles in suspension or solution in a solvent, typically water to measure a size distribution of the particles. Due to the details of the DLS setup, the technique measures a hydrodynamic diameter of the particles, which is the diameter of a sphere with an equivalent diffusion coefficient as the particles. The hydrodynamic diameter may include factors not accounted for by other methods such as non-crystalline material on the surface of particles such as bulky surface ligands, amorphous regions of particles, and surface ligand-solvent interactions. Further, the hydrodynamic diameter may not accurately account for non-spherical particle shapes. DLS does have an advantage of being able to account for or more accurately model solution or suspension behavior of the particles compared to other techniques. In some embodiments, the particle size is determined by electron microscopy techniques such as scanning electron microscopy (SEM) or transmission electron microscopy (TEM).

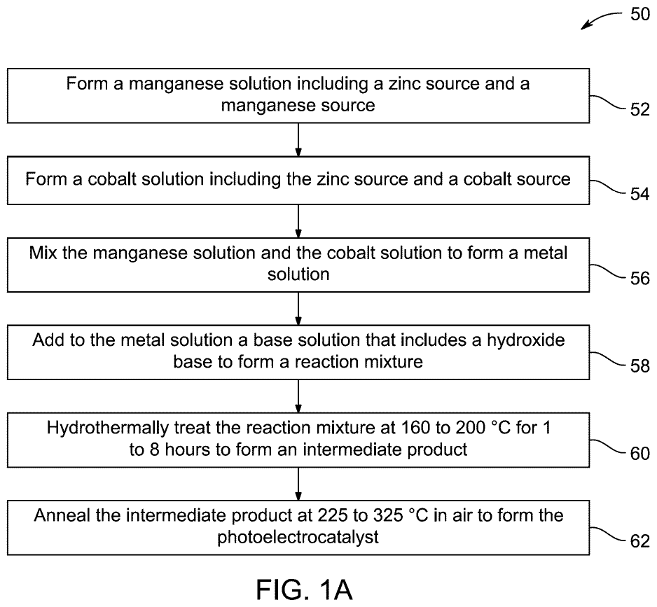

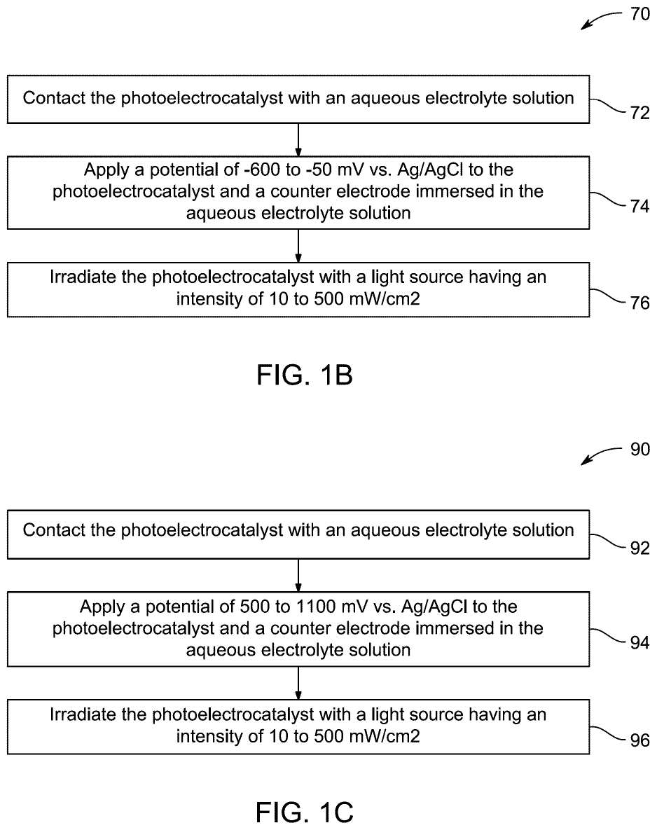

The present disclosure also relates to a method of forming the photoelectrocatalyst. FIG. 1A illustrates a schematic flow chart of a method 50 of forming the photoelectrocatalyst. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes forming a manganese solution including a zinc source and a manganese source. In some embodiments, the manganese source may include, but is not limited to, manganese chloride, manganese sulfate, manganese nitrate, manganese carbonate, manganese oxide, manganese hydroxide, manganese phosphate, manganese bromide, manganese iodide, manganese peroxide, manganese gluconate, manganese ascorbate, manganese citrate, manganese lactate, manganese propionate, manganese butyrate, manganese malate, manganese succinate, manganese formate, manganese pyrophosphate, manganese borate, manganese fumarate, manganese stearate, manganese sulfate, manganese ethylenediaminetetraacetate (Mg-EDTA), manganese formic acid complex, manganese tartrate, manganese bicarbonate, manganese glycolate, manganese acetoacetate, and manganese acetylacetonate. In some embodiments, the manganese source is manganese acetate.

In some embodiments, the zinc source may include, but is not limited to, zinc oxide, zinc sulfate, zinc chloride, zinc nitrate, zinc carbonate, zinc gluconate, zinc citrate, zinc lactate, zinc phosphate, zinc stearate, zinc ascorbate, zinc picolinate, zinc fumarate, zinc malate, zinc hydroxide, zinc sulfate heptahydrate, zinc borate, zinc glycinate, zinc pyrophosphate, zinc formate, zinc sulfate monohydrate, zinc bisglycinate, zinc methionine, zinc bisulfate, zinc stearate, zinc sulfide, zinc ammonium chloride, zinc formic acid complex, zinc taurinate, zinc orotate, zinc glycerophosphate, and zinc thiol complex. In some embodiments, the zinc source is zinc acetate.

At step 54, the method 50 includes forming a cobalt solution including the zinc source and a cobalt source. In some embodiments, the cobalt source may include but is not limited to cobalt chloride, cobalt sulfate, cobalt acetate, cobalt carbonate, cobalt oxide, cobalt hydroxide, cobalt phosphate, cobalt bromide, cobalt iodide, cobalt gluconate, cobalt ascorbate, cobalt citrate, cobalt lactate, cobalt propionate, cobalt butyrate, cobalt malate, cobalt succinate, cobalt formate, cobalt pyrophosphate, cobalt borate, cobalt fumarate, cobalt stearate, cobalt sulfate heptahydrate, cobalt ethylenediaminetetraacetate (EDTA), cobalt formic acid complex, cobalt tartrate, cobalt dibasic carbonate, cobalt glycolate, cobalt acetoacetate, cobalt acetylacetonate, and cobalt thiosulfate. In some embodiments, the cobalt source is cobalt nitrate.

At step 56, the method 50 includes mixing the manganese solution and the cobalt solution to form a metal solution.

At step 58, the method 50 includes adding to the metal solution a base solution that includes a hydroxide base to form a reaction mixture. In some embodiments, the hydroxide base may include, but is not limited to, potassium hydroxide, calcium hydroxide, magnesium hydroxide, lithium hydroxide, ammonium hydroxide, barium hydroxide, strontium hydroxide, rubidium hydroxide, cesium hydroxide, aluminum hydroxide, iron(III) hydroxide, zinc hydroxide, copper(II) hydroxide, nickel hydroxide, manganese(II) hydroxide, copper(I) hydroxide, beryllium hydroxide, lead(II) hydroxide, cadmium hydroxide, tin(II) hydroxide, tin(IV) hydroxide, cobalt(II) hydroxide, chromium(III) hydroxide, silver hydroxide, gold hydroxide, antimony(III) hydroxide, thallium hydroxide, mercury(II) hydroxide, chromium(VI) hydroxide, and ferrous hydroxide. In some embodiments, the hydroxide base is sodium hydroxide.

In some embodiments, the hydroxide base is present in the base solution at a concentration that may range from 0.01 to 0.5 M. For example, the hydroxide base may be present at a concentration of 0.01 M, 0.025 M, 0.05 M, 0.075 M, 0.1 M, 0.125 M, 0.15 M, 0.175 M, 0.20 M, 0.225 M, 0.25 M, 0.275 M, 0.30 M, 0.325 M, 0.35 M, 0.375 M, 0.40 M, 0.425 M, 0.45 M, 0.475 M, or 0.5 M. In some embodiments, the hydroxide base is present in the base solution at a concentration of 0.1 M.

At step 60, the method 50 includes hydrothermally treating the reaction mixture at 160 to 200° C. for 1 to 8 hours to form an intermediate product. In some embodiments, the reaction mixture may be hydrothermally treated at temperatures ranging from 160 to 200° C. For example, the reaction mixture may be hydrothermally treated at 160° C., 165° C., 170° C., 175° C., 180° C., 185° C., 190° C., 195° C., or 200° C. In some embodiments, the reaction mixture is hydrothermally treated at 180° C.

In some embodiments, the reaction mixture may be hydrothermally treated for 1 to 8 hours. For example, the reaction mixture may be hydrothermally treated for 1 hour, 1.5 hours, 2 hours, 2.5 hours, 3 hours, 3.5 hours, 4 hours, 4.5 hours, 5 hours, 5.5 hours, 6 hours, 6.5 hours, 7 hours, 7.5 hours, or 8 hours. In some embodiments, the reaction mixture is hydrothermally treated for 4 hours.

At step 62, the method 50 includes annealing the intermediate product at 225 to 325° C. in air to form the photoelectrocatalyst. For example, the intermediate product may be annealed at 225° C., 230° C., 235° C., 240° C., 245° C., 250° C., 255° C., 260° C., 265° C., 270° C., 275° C., 280° C., 285° C., 290° C., 295° C., 300° C., 305° C., 310° C., 315° C., 320° C., or 325° C. In some embodiments, the intermediate product may be annealed at around 270° C.

In some embodiments, the intermediate product is annealed for 1 to 8 hours. For example, the intermediate product may be annealed for 1 hour, 1.5 hours, 2 hours, 2.5 hours, 3 hours, 3.5 hours, 4 hours, 4.5 hours, 5 hours, 5.5 hours, 6 hours, 6.5 hours, 7 hours, 7.5 hours, or 8 hours. In some embodiments, the intermediate product is annealed for 2 hours.

The present disclosure also relates to a method of producing hydrogen gas with the photoelectrocatalyst. FIG. 1B illustrates a schematic flow chart of a method 70 of producing hydrogen gas by a hydrogen evolution reaction. The order in which the method 70 is described is not intended to be construed as a limitation, and any number of the described method steps can be combined to implement the method 70. Additionally, individual steps may be removed or skipped from the method 70 without departing from the spirit and scope of the present disclosure.

At step 72, the method 70 includes contacting the photoelectrocatalyst with an aqueous electrolyte solution. In some embodiments, the aqueous electrolyte solution includes an electrolyte. Examples of suitable electrolytes include, but are not limited to, potassium chloride, sodium chloride, magnesium sulfate, calcium chloride, potassium sulfate, sodium carbonate, ammonium chloride, lithium chloride, potassium nitrate, sodium nitrate, copper sulfate, zinc sulfate, nickel sulfate, lithium sulfate, ammonium sulfate, calcium nitrate, potassium hydroxide, sodium hydroxide, sodium bicarbonate, ammonium nitrate, lithium nitrate, potassium carbonate, sodium acetate, potassium acetate, ammonium acetate, sodium phosphate, potassium phosphate, lithium phosphate, zinc chloride, and nickel chloride. In some embodiments, the aqueous electrolyte solution contains sulfate anions. In some embodiments, the aqueous electrolyte solution contains sodium sulfate. In some embodiments, the aqueous electrolyte solution is a sodium sulfate solution.

In some embodiments, the aqueous electrolyte solution has a sulfate anion concentration ranging from 0.01 to 1.0 M. For example, the aqueous electrolyte solution may have a sulfate anion concentration of 0.01 M, 0.025 M, 0.05 M, 0.075 M, 0.1 M, 0.125 M, 0.15 M, 0.175 M, 0.20 M, 0.225 M, 0.25 M, 0.275 M, 0.30 M, 0.325 M, 0.35 M, 0.375 M, 0.40 M, 0.425 M, 0.45 M, 0.475 M, or 0.5 M. In some embodiments, the aqueous electrolyte solution has a sulfate anion concentration of 0.5 M.

In some embodiments, the method of contacting the photoelectrocatalyst with the aqueous electrolyte solution can be performed at a temperature of 15° C. to 60° C. For example, the contacting can be performed at 15° C., 20° C., 25° C., 30° C., 35° C., 40° C., 45° C., 50° C., 55° C., or 60° C.

At step 74, the method 70 includes applying a potential of −600 to −50 mV vs Ag/AgCl to the photoelectrocatalyst and a counter electrode immersed in the aqueous electrolyte solution. In some embodiments, a potential ranging from −600 to −50 mV vs Ag/AgCl. For example, the applied potential can be −600 mV, −575 mV, −550 mV, −525 mV, −500 mV, −475 mV, −450 mV, −425 mV, −400 mV, −375 mV, −350 mV, −325 mV, −300 mV, −275 mV, −250 mV, −225 mV, −200 mV, −175 mV, −150 mV, −125 mV, −100 mV, −75 mV, or −50 mV vs Ag/AgCl. In some embodiments, the potential applied to the photoelectrocatalyst is −300 mV vs Ag/AgCl. In some embodiments, the potential applied to the photoelectrocatalyst is −100 mV vs Ag/AgCl.

In general, the counter electrode may be any suitable counter electrode known to one of ordinary skill in the art. Examples of suitable counter electrodes include, but are not limited to, a gold electrode, a silver electrode, a copper electrode, a graphite electrode, a glassy carbon electrode, an iridium electrode, a rhodium electrode, a palladium electrode, a tungsten electrode, a titanium electrode, a stainless steel electrode, a nickel electrode, a lead electrode, a zinc electrode, a tin electrode, a silver chloride electrode, a copper oxide electrode, a carbon nanotube electrode, a graphene electrode, a platinum-coated electrode, a carbon fiber electrode, a conductive diamond electrode, an antimony electrode, a mercury electrode, a brass electrode, a bronze electrode, a molybdenum electrode, an indium electrode, an aluminum electrode, or a bismuth electrode. In some embodiments, the counter electrode is a platinum electrode.

In general, the reference electrode may be any suitable reference electrode known to one of ordinary skill in the art. Examples of suitable reference electrodes include, but are not limited to, a silver/silver chloride electrode, a reference electrode based on a saturated sodium chloride solution, a mercury/mercurous sulfate electrode, a copper/copper sulfate electrode, a calomel reference electrode, a lithium reference electrode, a hydrogen reference electrode, a saturated potassium chloride electrode, a silver/silver nitrate electrode, a quinhydrone electrode, a saturated lithium chloride electrode, a zinc/zinc sulfate electrode, a silver/silver oxide electrode, a gold/gold oxide electrode, a copper/oxide electrode, a titanium/titanium oxide electrode, or a nickel/nickel oxide electrode. In a preferred embodiment, the reference electrode is saturated calomel electrode (SCE).

At step 76, the method 70 includes irradiating the photoelectrocatalyst with a light source having an intensity of 10 mW/cm² to 500 mW/cm². In some embodiments, the photoelectrocatalyst is irradiated with the light source that may include, but is not limited to, xenon lamp, halogen lamp, LED, tungsten filament lamp, fluorescent lamp, mercury vapor lamp, metal halide lamp, sodium vapor lamp, laser diode, carbon arc lamp, deuterium lamp, arc lamp, electrodeless discharge lamp, supercontinuum laser, monochromatic light source, white LED, ultraviolet LED, infrared LED, phosphor-converted LED, high-pressure mercury lamp, low-pressure mercury lamp, halide xenon lamp, copper vapor laser, nitrogen laser, diode-pumped solid-state laser, argon ion laser, dye laser, ruby laser, and erbium laser. In preferred embodiments, the light source is solar stimulator, calibrated with a silicon diode solar cell.

In some embodiments, the intensity of light source may range from 10 to 500 mW/cm². For example, the light source may have an intensity of 10 mW/cm², 15 mW/cm², 20 mW/cm², 25 mW/cm², 30 mW/cm², 35 mW/cm², 40 mW/cm², 45 mW/cm², 50 mW/cm², 75 mW/cm², 100 mW/cm², 125 mW/cm², 150 mW/cm², 175 mW/cm², 200 mW/cm², 225 mW/cm², 250 mW/cm², 275 mW/cm², 300 mW/cm², 325 mW/cm², 350 mW/cm², 375 mW/cm², 400 mW/cm², 425 mW/cm², 450 mW/cm², 475 mW/cm², or 500 mW/cm². In some embodiments, the intensity of light source is 100 mW/cm².

In some embodiment, the photoelectrocatalyst has a peak photocurrent density ranging from 6 μA/cm² to 20 μA/cm². For example, the photocatalyst may have a peak photocurrent density of 6.0 μA/cm², 6.5 μA/cm², 7.0 μA/cm², 7.5 μA/cm², 8.0 μA/cm², 8.5 μA/cm², 9.0 μA/cm², 9.5 μA/cm², 10.0 μA/cm², 10.5 μA/cm², 11.0 μA/cm², 11.5 μA/cm², 12.0 μA/cm², 12.5 μA/cm², 13.0 μA/cm², 13.5 μA/cm², 14.0 μA/cm², 14.5 μA/cm², 15.0 μA/cm², 15.5 μA/cm², 16.0μ A/cm², 16.5μ A/cm², 17.0μ A/cm², 17.5μ A/cm², 18.0μ A/cm², 18.5μ A/cm², 19.0 μA/cm², 19.5 μA/cm², or 20.0 μA/cm². In some embodiments, the photoelectrocatalyst has a peak photocurrent density of 14 μA/cm².

In some embodiments, the photoelectrocatalyst has a photocurrent density at an applied potential of −100 mV vs Ag/AgCl ranging from 5 μA/cm² to 7.5 μA/cm². For example, the photoelectrocatalyst may have a photocurrent density at an applied potential of −100 mV vs Ag/AgCl of 5.0 μA/cm², 5.1 μA/cm², 5.2 μA/cm², 5.3 μA/cm², 5.4 μA/cm², 5.5 μA/cm², 5.6 μA/cm², 5.7 μA/cm², 5.8 μA/cm², 5.9 μA/cm², 6.0 μA/cm², 6.1 μA/cm², 6.2 μA/cm², 6.3 μA/cm², 6.4 μA/cm², 6.45 μA/cm², 6.6 μA/cm², 6.7 μA/cm², 6.8 μA/cm², 6.9 μA/cm², 7.0 μA/cm², 7.1 μA/cm², 7.2 μA/cm², 7.3 μA/cm², 7.4 μA/cm², or 7.5 μA/cm².

In some embodiments, photoelectrocatalyst has a ratio of photocurrent density to current density without illumination at an applied potential of −300 mV vs Ag/AgCl ranging from 2:1 to 3.5:1. For example, the photoelectrocatalyst may have a ratio of photocurrent density to current density without illumination at an applied potential of −300 mV vs Ag/AgCl of 2:1, 2.1:1, 2.2:1, 2.3:1, 2.4:1, 2.5:1, 2.6:1, 2.7:1, 2.8:1, 2.9:1, 3.0:1, 3.1:1, 3.2:1, 3.3:1, 3.4:1, or 3.5:1. at an applied potential of −300 mV vs Ag/AgCl.

The present disclosure also relates to a method of producing oxygen gas with the photoelectrocatalyst. FIG. 1C illustrates a schematic flow chart of a method 90 of producing oxygen gas by an oxygen evolution reaction. The order in which the method 90 is described is not intended to be construed as a limitation, and any number of the described method steps can be combined to implement the method 90. Additionally, individual steps may be removed or skipped from the method 90 without departing from the spirit and scope of the present disclosure.

At step 92, the method 90 includes contacting the photoelectrocatalyst with an aqueous electrolyte solution. In some embodiments, the aqueous electrolyte solution includes an electrolyte. Examples of suitable electrolytes include, but are not limited to, potassium chloride, sodium chloride, magnesium sulfate, calcium chloride, potassium sulfate, sodium carbonate, ammonium chloride, lithium chloride, potassium nitrate, sodium nitrate, copper sulfate, zinc sulfate, nickel sulfate, lithium sulfate, ammonium sulfate, calcium nitrate, potassium hydroxide, sodium hydroxide, sodium bicarbonate, ammonium nitrate, lithium nitrate, potassium carbonate, sodium acetate, potassium acetate, ammonium acetate, sodium phosphate, potassium phosphate, lithium phosphate, zinc chloride, and nickel chloride. In some embodiments, the aqueous electrolyte solution contains sulfate anions. In some embodiments, the aqueous electrolyte solution contains sodium sulfate. In some embodiments, the aqueous electrolyte solution is a sodium sulfate solution.

In some embodiments, the aqueous electrolyte solution has a sulfate anion concentration ranging from 0.01 to 1.0 M. For example, the aqueous electrolyte solution may have a sulfate anion concentration of 0.01 M, 0.025 M, 0.05 M, 0.075 M, 0.1 M, 0.125 M, 0.15 M, 0.175 M, 0.20 M, 0.225 M, 0.25 M, 0.275 M, 0.30 M, 0.325 M, 0.35 M, 0.375 M, 0.40 M, 0.425 M, 0.45 M, 0.475 M, or 0.5 M. In some embodiments, the aqueous electrolyte solution has a sulfate anion concentration of 0.5 M.

At step 94, the method 90 includes applying a potential of 500 to 1100 mV vs Ag/AgCl to the photoelectrocatalyst and a counter electrode immersed in the aqueous electrolyte solution. For example, the applied potential can be 500 mV, 525 mV, 550 mV, 575 mV, 600 mV, 625 mV, 650 mV, 675 mV, 700 mV, 725 mV, 750 mV, 775 mV, 800 mV, 825 mV, 850 mV, 875 mV, 900 mV, 925 mV, 950 mV, 975 mV, 1000 mV, 1025 mV, 1050 mV, 1075 mV, or 1100 mV vs Ag/AgCl. In some embodiments, the potential applied to the photoelectrocatalyst is 800 mV vs Ag/AgCl.

In general, the counter electrode may be any suitable counter electrode known to one of ordinary skill in the art. Examples of suitable counter electrodes include, but are not limited to, a gold electrode, a silver electrode, a copper electrode, a graphite electrode, a glassy carbon electrode, an iridium electrode, a rhodium electrode, a palladium electrode, a tungsten electrode, a titanium electrode, a stainless steel electrode, a nickel electrode, a lead electrode, a zinc electrode, a tin electrode, a silver chloride electrode, a copper oxide electrode, a carbon nanotube electrode, a graphene electrode, a platinum-coated electrode, a carbon fiber electrode, a conductive diamond electrode, an antimony electrode, a mercury electrode, a brass electrode, a bronze electrode, a molybdenum electrode, an indium electrode, an aluminum electrode, or a bismuth electrode. In some embodiments, the counter electrode is a platinum electrode.

In general, the reference electrode may be any suitable reference electrode known to one of ordinary skill in the art. Examples of suitable reference electrodes include, but are not limited to, a silver/silver chloride electrode, a reference electrode based on a saturated sodium chloride solution, a mercury/mercurous sulfate electrode, a copper/copper sulfate electrode, a calomel reference electrode, a lithium reference electrode, a hydrogen reference electrode, a saturated potassium chloride electrode, a silver/silver nitrate electrode, a quinhydrone electrode, a saturated lithium chloride electrode, a zinc/zinc sulfate electrode, a silver/silver oxide electrode, a gold/gold oxide electrode, a copper/oxide electrode, a titanium/titanium oxide electrode, or a nickel/nickel oxide electrode. In a preferred embodiment, the reference electrode is saturated calomel electrode (SCE).

At step 96, the method 90 includes irradiating the photoelectrocatalyst with a light source having an intensity of 10 to 500 mW/cm². In some embodiments, the photoelectrocatalyst is irradiated with the light source that may include, but is not limited to, xenon lamp, halogen lamp, LED, tungsten filament lamp, fluorescent lamp, mercury vapor lamp, metal halide lamp, sodium vapor lamp, laser diode, carbon arc lamp, deuterium lamp, arc lamp, electrodeless discharge lamp, supercontinuum laser, monochromatic light source, white LED, ultraviolet LED, infrared LED, phosphor-converted LED, high-pressure mercury lamp, low-pressure mercury lamp, halide xenon lamp, copper vapor laser, nitrogen laser, diode-pumped solid-state laser, argon ion laser, dye laser, ruby laser, and erbium laser. In preferred embodiments, the light source is solar stimulator, calibrated with a silicon diode solar cell.

In some embodiments, the intensity of light source may range from 10 to 500 mW/cm². For example, the light source may have an intensity of 10 mW/cm², 15 mW/cm², 20 mW/cm², 25 mW/cm², 30 mW/cm², 35 mW/cm², 40 mW/cm², 45 mW/cm², 50 mW/cm², 75 mW/cm², 100 mW/cm², 125 mW/cm², 150 mW/cm², 175 mW/cm², 200 mW/cm², 225 mW/cm², 250 mW/cm², 275 mW/cm², 300 mW/cm², 325 mW/cm², 350 mW/cm², 375 mW/cm², 400 mW/cm², 425 mW/cm², 450 mW/cm², 475 mW/cm², or 500 mW/cm². In some embodiments, the intensity of light source is 100 mW/cm².

In some embodiments, the photoelectrocatalyst has a peak photocurrent density ranging from 1.25 μA/cm² to 4.0 μA/cm². For example, the photoelectrocatalyst may have a peak photocurrent density of 1.25 μA/cm², 1.5 μA/cm², 1.75 μA/cm², 2.0 μA/cm², 2.25 μA/cm², 2.5 μA/cm², 2.75 μA/cm², 3.0 μA/cm², 3.25 μA/cm², 3.5 μA/cm², 3.75 μA/cm², or 4.0 μA/cm². In some embodiments, the photoelectrocatalyst has a peak photocurrent density of 2.9 μA/cm².

In some embodiments, the photoelectrocatalyst has a photocurrent density at an applied potential of 800 mV vs Ag/AgCl ranging from 0.75 μA/cm² to 1.5 μA/cm². For example, the photoelectrocatalyst may have a photocurrent density at an applied potential of 800 mV vs Ag/AgCl of 0.75 μA/cm², 0.80 μA/cm², 0.85 μA/cm², 0.90 μA/cm², 0.95 μA/cm², 1.0 μA/cm², 1.05 μA/cm², 1.10 μA/cm², 1.15 μA/cm², 1.20 μA/cm², 1.25 μA/cm², 1.30 μA/cm², 1.35 μA/cm², 1.40 μA/cm², 1.45 μA/cm², or 1.5 μA/cm².

In some embodiment, the photoelectrocatalyst has a ratio of photocurrent density to current density without illumination at an applied potential of 800 mV vs Ag/AgCl ranging from 1.5:1 to 4:1. For example, the photoelectrocatalyst may have a ratio of photocurrent density to current density without illumination at an applied potential of 800 mV vs Ag/AgCl of 1.5:1, 1.6:1, 1.7:1, 1.8:1, 1.9:1, 2.0:1, 2:1, 2.1:1, 2.2:1, 2.3:1, 2.4:1, 2.5:1, 2.6:1, 2.7:1, 2.8:1, 2.9:1, 3.0:1, 3.1:1, 3.2:1, 3.3:1, 3.4:1, 3.5:1, 3.6:1, 3.7:1, 3.8:1, 3.9:1, or 4:1.

### EXAMPLES

The following examples demonstrate a manganese and cobalt co-doped ZnO photocatalyst utilized for water-splitting reactions. The examples are provided solely for illustration and are not to be construed as limitations of the present disclosure, as many variations thereof are possible without departing from the spirit and scope of the present disclosure.

### Example 1: Materials

All analytical-grade chemicals were sourced from third parties and used as received. Zinc acetate dihydrate (ZAD), cobalt nitrate hexahydrate (CNX), manganese (II) acetate tetrahydrate (MAT), and NaOH were sourced from Sigma Aldrich. All examinations and evaluations used deionized water (DI) with a resistivity of about 18.2 MΩ, using a Millipore reverse osmosis water system.

### Example 2: Synthesis of CZO and MCZO

70 mL of DI water was used to dissolve 0.035 mol of ZAD. The solution was supplemented with a plurality of Mn and Zn molar ratios with R_{Mn/Zn}=0% and 0.8% of MAT and CNX. However, the Co/Zn molar ratio (R_{Co/Zn}) was 1.5%. Until the solutions were evenly dispersed, a room-temperature NaOH solution with a concentration of 0.1 mol in 100 mL DI water was added gradually and stirred. At the same temperature, the reaction mixture was stirred for 1 hour. Furthermore, the reaction mixture was transferred to an autoclave lined with Teflon and heated at 180° C. for 4 hours to yield Mn—Zn co-doped ZnO (MCZO) nanoparticles (NPs). The produced NPs were centrifuged for 3.30 minutes at 10,000 revolutions per minute (rpm) after being repeatedly cleaned with DI water. Moreover, the solution was dried for a day at 70° C. in a vacuum oven, post-annealing for two hours at 270° C. in air. For Co-doped ZnO NPs synthesis, the above-described procedure was followed without manganese (Mn) precursor.

### Example 3: Material Characterization

The characterization of the CZO and MCZO nanoparticles (NPs) was carried out utilizing analytical techniques, including X-ray diffraction (XRD) with a Rigaku Miniflex-II diffractometer using Cu/Kα radiation (λ=1.5406 Å), Fourier-transform infrared (FTIR) spectroscopy using a Smart iTR NICOLET iS10 instrument, field-emission scanning electron microscopy (FESEM) with a JEOL SEM (Model: JSM6610LV) for high-resolution imaging and energy dispersive X-ray (EDS) analysis, UV-vis-NIR spectroscopy with a JASCO spectrometer (Model: UV-670). Further, for optical absorption, photoluminescence measurements using a Fluorolog iHR 320 model, X-ray fluorescence (XRF) examination with an Xepos model, and high-resolution transmission electron microscopy (HRTEM) using Model: JEM2100F, to analyze the microstructure and size distribution of the nanoparticles, providing a comprehensive understanding of the structural, compositional, and optoelectronic properties of the MCZO NPs.

### Example 4: Photochemical Measurements

The synthesized NPs were dispersed in isopropanol at a concentration of 20 milligrams per milliliter (mg mL⁻¹) and 5 μL of Nafion was added to the suspension. F-doped tin oxide (FTO) glasses were cleaned in Piranha solution for 10 minutes, followed by a rinse with DI water. The electrodes were prepared by spin-coating using an EZ4 model spin coater, the NP suspension was coated onto the FTO surface, which resulted in an active electrode area of 1×1 cm². The fabricated electrodes were tested for overall water-splitting performance in a three-electrode photoelectrochemical cell. The electrolyte solution, including 0.5 M Na₂SO₄, was prepared using sodium sulfate (>99.0%) dissolved in DI water (resistivity <18.2 MΩ). The cell was equipped with a saturated calomel electrode (SCE) as the reference electrode, the fabricated electrode as the working electrode, and a platinum (Pt) electrode as the counter electrode. The cell was connected to an Autolab potentiostat with NOVA 2.1 software. The light source was an Oriel Sol-AAA (Newport) solar simulator, calibrated with a silicon diode solar cell (Oriel-diode) fixed at 100 mW/cm². The solar simulator was fitted with AM-1.5G and UV cut-off (λ>420 nm) filters to simulate the desired light conditions.

### Example 5: Physical Characterization Results

XRD analysis was used to examine the crystalline quality of the MCZO NPs, as shown in FIG. 1A. For the diffraction plane of (100), (002), (101), (102), (110), (103), (200), (112), and (201), respectively, the diffraction peaks for the sample x=0 emerge at 2θ=31.86°, 34.44°, 36.28°, 47.59°, 56.62°, 62.91°, 66.41°, 67.8°, and 69.02°. The crystalline phase matched the hexagonal wurtzite phase of zinc oxide (JCPDS: 36-1451).

Incorporating Mn (at x=0.8%) shifted the XRD peaks towards higher 20 values due to the reduction in lattice spacing. Additionally, the XRD peak intensity of the MCZO increased with the addition of Mn, indicating an enhancement in crystallinity. The crystallite size (D) of the MCZO was determined using Debye-Scherrer's relation as provided below in equation (1),

$${D}_{hkl} = \frac{0.9 {λ}_{XRD}}{{β}_{hkl} cos θ} \qquad ( 1 )$$

where, ‘β’ stands for the angular full width at half maximum (in radians), ‘θ’ is Bragg's diffraction angle, and ‘λ_{XRD}’ for the wavelength of the X-rays that were employed (1.5408 Å). Equation (2) was used to determine the plane spacing (d).

$${d}_{hkl} = \frac{{λ}_{XRD}}{2 sin θ} \qquad ( 2 )$$

Table 1 lists the values for crystallite size, d-spacing, and peak positions. For undoped and Mn-doped NPs, the inter-planar spacing (d₁₀₁) corresponding to the (101) plane is 2.474 Å and 2.473 Å, respectively. According to Table 1, the average crystallite sizes were 40.31 nm and 42.66 nm. This indicates that the crystallite size decreases due to Mn doping.

TABLE 1
Structural parameters obtained from XRD data of MCZO.

Diffracting angle, 2θ (°)

| Sample | (100) | (002) | (101) | (102) | (110) |
|---|---|---|---|---|---|
| MCZO-0% | 31.86 | 34.44 | 36.28 | 47.59 | 56.62 |
| MCZO-0.8% | 31.87 | 34.51 | 36.29 | 47.59 | 56.55 |

| | Peak position, 2θ (°) | Inter-planar | Crystallite |
|---|---|---|---|
| Sample | for (101) plane | spacing, d₁₀₁ (Å) | size (nm) |
| MCZO-0% | 36.28 | 2.474 | 42.66 |
| MCZO-0.8% | 36.29 | 2.473 | 40.31 |

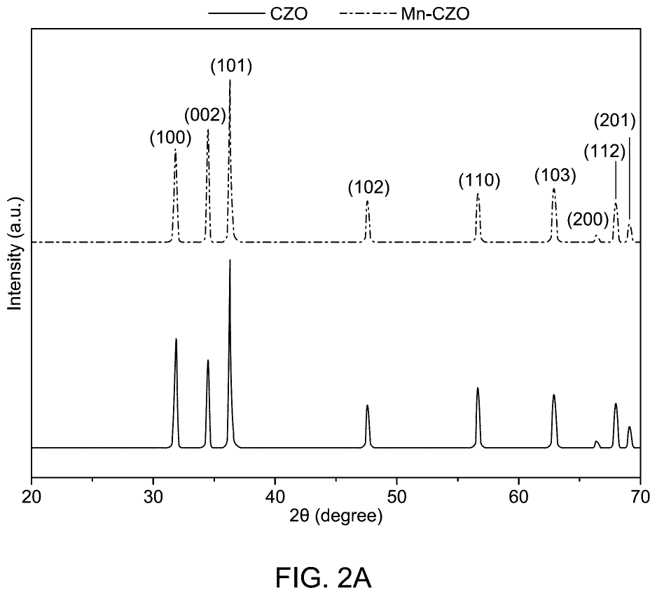

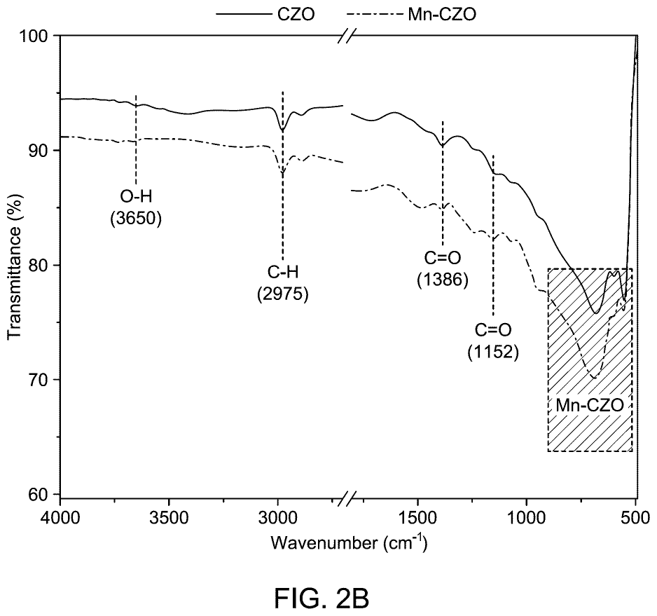

FIG. 2B shows the FTIR spectra of MCZO. The FTIR absorption range of 500 cm⁻¹ to 600 cm⁻¹ includes a plurality of FTIR absorption peaks associated with the Zn—O stretching mode [Xiong G, et. al., Phys. Status Solidi (c), 2006, 3, 3577-3581, incorporated herein by reference in its entirety]. The addition of Mn increased the intensity of the absorption peak. Concerning the overlapping of the Mn—O and Co—O stretching modes, a peak was observed in all of the samples at 620 cm⁻¹ [Ullah R, & Dutta J., J Hazard Mater, 2008, 156, 194-200, incorporated herein by reference in its entirety]. This indicates successful insertion of Co²⁺ and Mn²⁺ ions into the Zn²⁺ sites of the ZnO lattice [Karthika K, et. al., Ceram Int, 2015, 41, 7944-51, incorporated herein by reference in its entirety]. The stretching vibration of C═O is responsible for the absorption band at about 1548 cm⁻¹ (symmetric) and approximately 1384 cm⁻¹ (asymmetric) [Maensiri S, et. al., J Magn Magn Mater, 2006, 301, 422-32, incorporated herein by reference in its entirety].

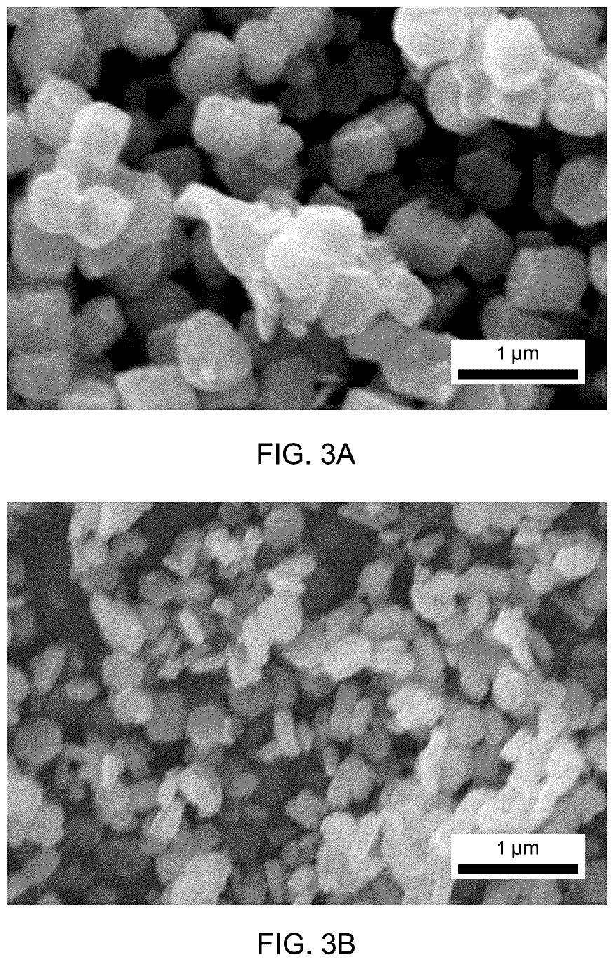

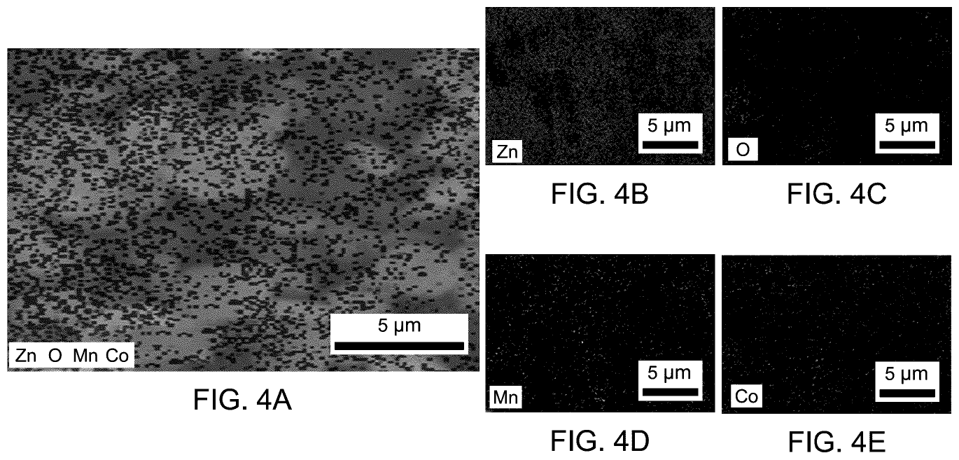

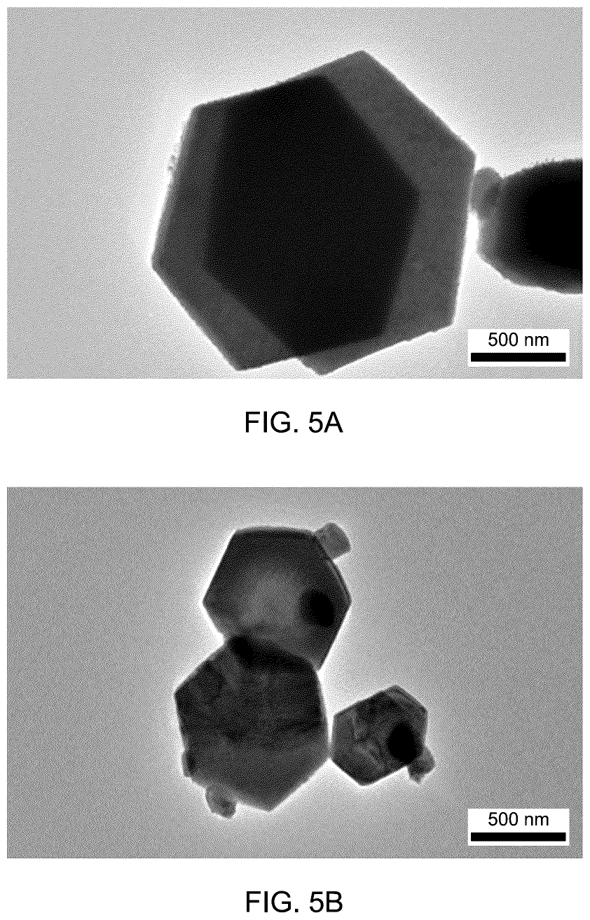

Morphological analyses were carried out using TEM and FESEM analysis. The nanoparticles had a well-defined grain size and a disc-like hexagonal shape, as shown in FIGS. 3A-3B. Further, as shown in FIGS, EDS mapping was used to analyze the elemental distribution. 4A-4E. The EDS results showed the presence of Zn, O, Co, and Mn, confirming the doping of Mn and Co. Furthermore, every component demonstrated an even distribution throughout the sample. The decrease in nanoparticle size, as observed from TEM images when the Mn was incorporated, is attributed to the Zener pinning effect. TEM images are shown in FIGS. 5A-5B. The smaller size of Mn²⁺ ions of about 0.065 nm in comparison to Zn²⁺ ions of about 0.072 nm is the cause of the phenomena [Gu Z, et. al., Thin Solid Films, 2006, 515, 2361-5, incorporated herein by reference in its entirety].

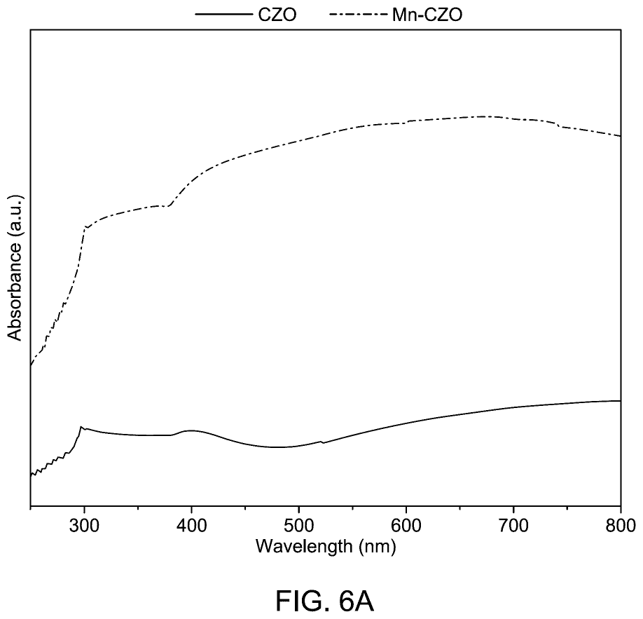

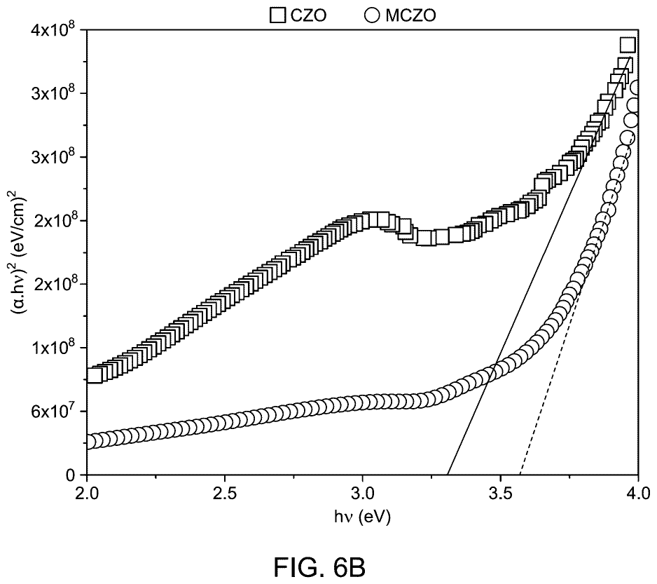

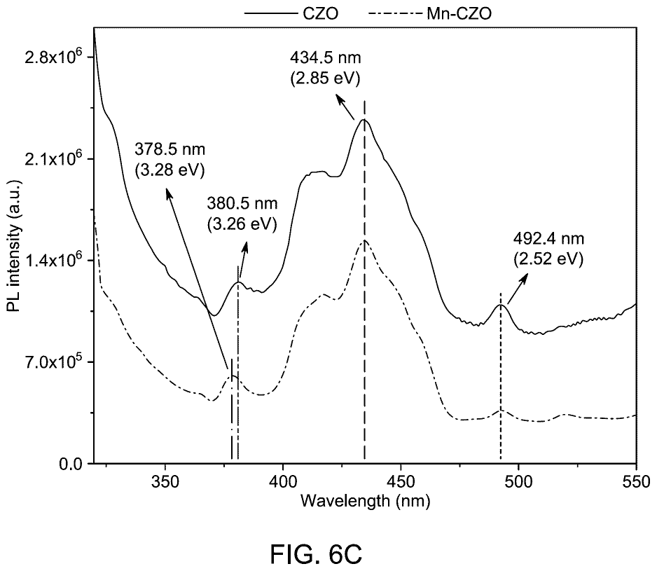

Material absorption is vital for optoelectronic and photochemical applications, and in particular, for oxygen evolution reaction (OER) and hydrogen evolution reaction (HER). Evaluations on the absorption properties of the MCZO layer were conducted on a glass substrate. The absorption spectra of the MCZO layer were measured between 250 nm and 800 nm in wavelength, as shown in FIG. 6A. The addition of Mn led to noticeably higher absorption. In addition, the Tauc plots were utilized to determine the bandgap (E_{g}), as depicted in FIG. 6B. For CZO and MCZO, the estimated values for E_{g} were noted to be about 3.39 eV and 3.61 eV, respectively. The Burstein-Moss effect, which may result from the replacement of Zn²⁺ with Mn²⁺ or the blockage of the lowest states in the conduction band, may be the origin of this rise in the energy bandgap values [Wu K-Y, et. al., Nanotechnology, 2007, 18, 305604; Berggren K-F, & Sernelius B E, Phys Rev B, 1981, 24, 1971, and Sernelius B E, Phys Rev B, 1987, 36, 4878, each of which is incorporated herein by reference in its entirety]. On the other hand, different results were found for ZnO films co-doped with Ag and Al [Khan F, et. al., J Alloys Compd, 2014, 584, 190-4, and Khan F, et. al., J Alloys Compd, 2015, 647, 566-72, each of which is incorporated herein by reference in its entirety]. In addition, photoluminescence (PL) examination was used to investigate flaws and evaluate the crystalline quality. The PL spectra of the MCZO samples show four strong peaks at 382 nm, 418 nm, 436 nm, and 491 nm for x=0, as shown in FIG. 6C. The near band-edge emission (NBE) of ZnO peaks at 382 nm, which is the band-to-band transition [Khan F, et. al., J Alloys Compd, 2016, 682, 232-7, incorporated herein by reference in its entirety]. Zinc interstitials is responsible for the most prominent peak at 436 nm; this peak arises from the transition between the valence band and the donor level of zinc interstitial [Zeferino R S, et. al., J Appl Phys, 2011, 109, incorporated herein by reference in its entirety]. Furthermore, a peak at 493 nm indicates the presence of oxygen vacancies in MCZO. It is evident that adding Mn increases the intensity of every peak, except for NBE.

### Example 6: Catalytic Evaluations

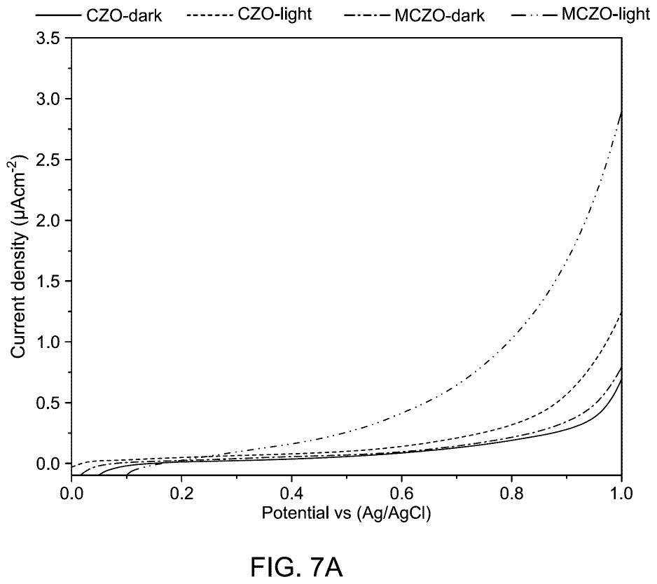

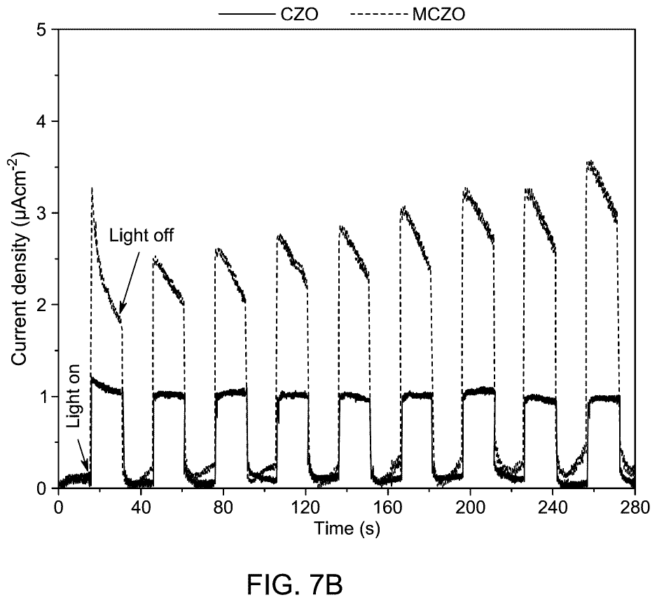

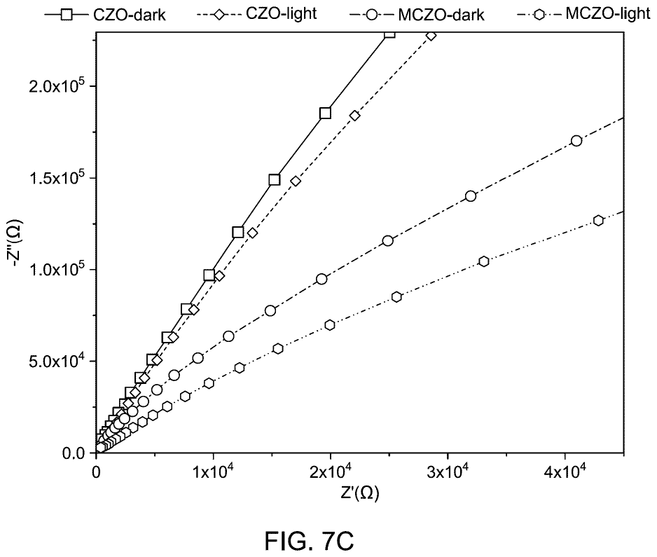

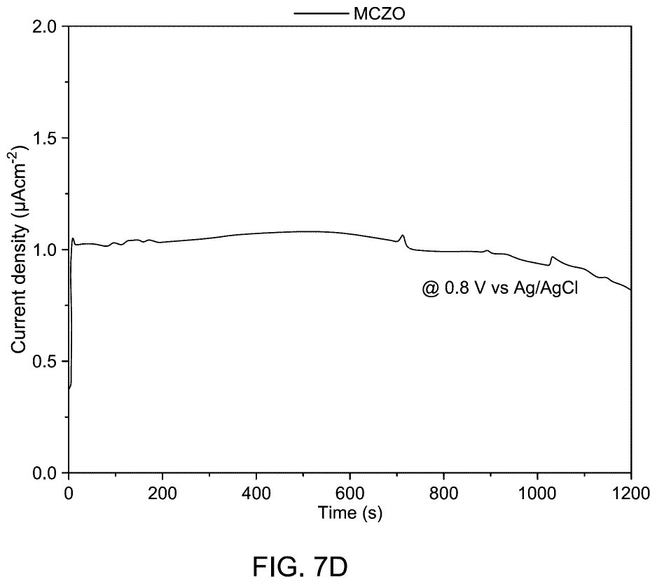

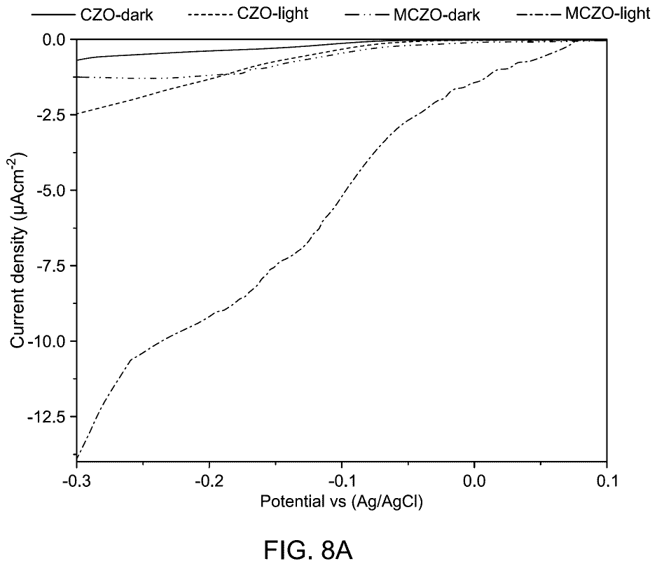

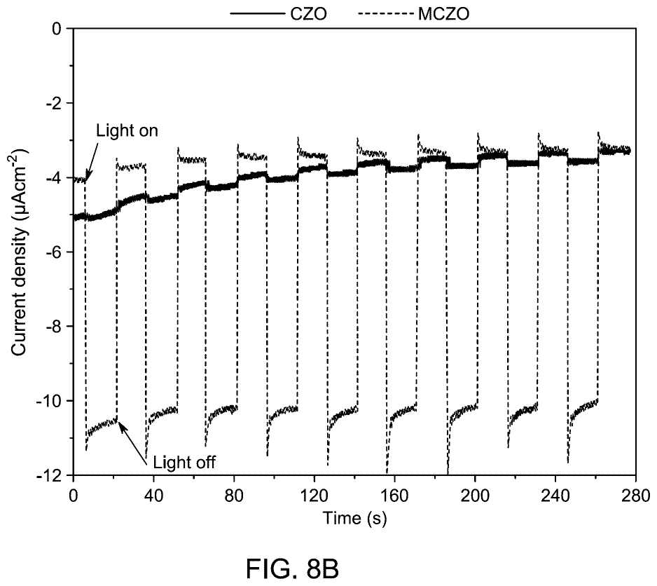

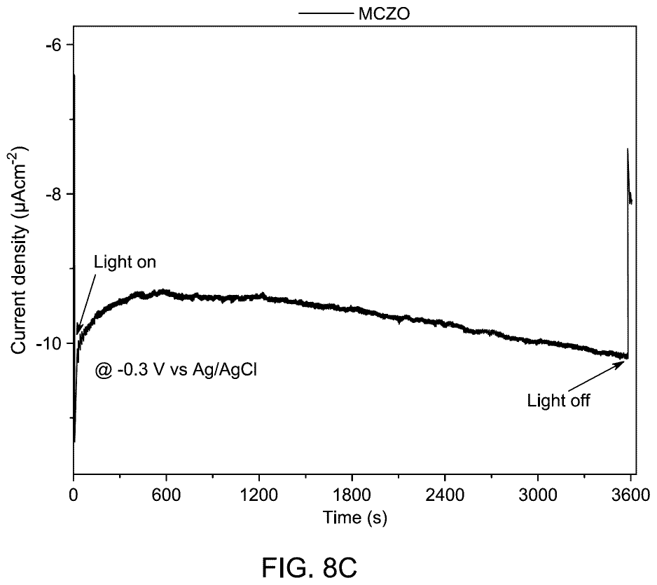

The synthesized co-doped ZnO (CZO) and Mn—Co co-doped ZnO (MCZO) electrodes were evaluated as bifunctional photocatalysts by examining oxygen OER and HER of the electrodes in a 0.5 M Na₂SO₄ electrolyte. FIG. 7A shows the linear sweep voltammetry (LSV) plot for the CZO and MCZO electrodes under dark and illuminated conditions. The LSV analysis revealed that CZO and MCZO electrodes exhibited significantly enhanced photocurrent densities under illumination compared to dark conditions. However, the MCZO electrode demonstrated a substantially higher peak photocurrent density of 2.9×10⁻⁶ A/cm², representing a 2.5-fold improvement over the CZO electrode. The transient photocurrent responses, under alternating light and dark cycles of 30-second intervals of the CZO and MCZO electrodes, were tested to gain insights into the generation and separation of charge carriers, and the results are illustrated in FIG. 7B. The transient photocurrent responses of the CZO and MCZO electrodes depicted a prompt generation of photocurrent upon turning on the light, followed by a gradual decay and an immediate drop when the light was switched off. In the case of MCZO, spike currents were generated, and the current response was much higher than CZO. This photo-response during the successive cycles was effectively repeated, indicating the periodic generation of excitons. The above-described behavior is characteristic of the periodic generation of photogenerated charge carriers, indicating the ability of the CZO and MCZO electrodes to effectively separate and utilize the photogenerated excitons for the desired electrochemical reactions.

The electrochemical impedance spectroscopy (EIS) measurements were conducted to evaluate the charge transfer resistance of the CZO and MCZO electrodes under dark and illuminated conditions. The measurements were conducted at 1.0 V vs. Ag/AgCl reference electrode in the frequency range of 1 Hz to 105 Hz. The EIS results, shown in FIG. 7C, reveals distinct differences between the two electrodes. Under dark conditions, both CZO and MCZO exhibit higher impedance values, indicating lower conductivity or higher charge transfer resistance. However, upon illumination, the impedance of both materials decreases significantly, suggesting an enhancement in conductivity and charge transfer. The above-mentioned observation may be attributed to generating electron-hole pairs under light exposure. The photogenerated charge carriers contribute to the increased mobility and concentration of charge carriers within the materials, leading to decreased impedance. Furthermore, the plot indicates that MCZO demonstrates a slightly lower impedance compared to CZO under both dark and light conditions [Galán-González A, et. al., ACS Appl Nano Mater 2020; 3:7781-8, incorporated herein by reference in its entirety].

In addition, the long-term stability of photoelectrochemical materials is a crucial factor in determining the practical applicability of photoelectrochemical materials for solar energy conversion devices. The long-term stability of the MCZO electrode was evaluated under illumination and positive bias conditions. The measurements were conducted at 0.8 V vs. Ag/AgCl reference electrode for a duration of 1200 seconds to evaluate the performance of the electrode over an extended period. FIG. 7D shows that the MCZO electrode exhibited stable performance for the initial 700 seconds under the applied bias and illumination. However, after this period, a gradual degradation in the performance of the electrode was observed, with the rate of degradation increasing over time. The aforementioned observation suggests that the MCZO electrode may maintain the photoelectrochemical activity for a limited duration under the tested conditions. The initial stability indicates the ability of the electrode to efficiently generate and separate photo-induced charge carriers, enabling effective charge transport and utilization for the desired PEC reactions.

The superior photoelectrochemical performance of the MCZO electrode compared to the CZO electrode for PEC water oxidation may be attributed to altered structural and optical features [Safeen A, et. al., RSC Adv 2022; 12:11923-32, incorporated herein by reference in its entirety]. The MCZO sample exhibited better light absorption in the visible region, as shown in FIG. 6A, due to the introduction of Mn dopants, which create additional energy levels within the bandgap of ZnO. The enhanced light absorption contributes to the enhanced generation of charge carriers. The MCZO sample shows a lower photoluminescence intensity, indicating that the Mn dopants effectively suppress the recombination of photogenerated electron-hole pairs, leading to enhanced charge separation, as shown in FIG. 6C. Moreover, incorporating Mn into the CZO matrix may introduce new energy levels within the bandgap, facilitating the separation and transfer of photogenerated charge carriers and contributing to the enhanced overall photoelectrochemical activity. Hence, the synergistic effect of Mn and Co co-doping in the MCZO electrode likely significantly improves the charge separation efficiency and suppressed charge recombination, leading to enhanced efficiency compared to the CZO electrode. Furthermore, the MCZO electrode exhibits better photoelectrochemical efficiency despite having a larger bandgap of 3.6 eV compared to 3.3 eV of the CZO electrode, which may be attributed to the aforementioned factors.

The instant generation of photocurrent during the successive ON/OFF cycles may be attributed to the initial surge of photogenerated charge carriers when the light is turned on, followed by gradual recombination and transport of the carriers through the material. The spike in photocurrent corresponds to this initial non-equilibrium state of high charge carrier concentration, and the subsequent decay reflects the various recombination processes and charge carrier transport dynamics. When the light is turned off, the remaining charge carriers quickly recombine or are extracted, leading to an instant drop in the photocurrent, suggesting that the co-doping of Mn and Co in ZnO may result in a higher concentration of charge carriers or lower resistance to current flow within the MCZO material, contributing to its improved electrical properties.

The CZO and MCZO electrodes were also tested for the hydrogen evolution reaction to assess their efficacy as bifunctional photocatalysts. The PEC performance of the CZO and MCZO electrodes was evaluated using the same electrolyte. LSV was performed by sweeping the potential from 0.2 to −0.3 V vs. Ag/AgCl. The corresponding LSV plots under dark and illuminated conditions for the CZO and MCZO electrodes showed that the current density was significantly higher under light conditions compared to the dark conditions for both electrodes, with the current density for the MCZO electrode reaching 14 μA/cm², which was about 6 times higher than that of the CZO electrode at 2.5 μA/cm².

The photocurrent response of CZO and MCZO samples was investigated under chopped illumination with a 30-second interval between light and dark periods, where the samples were employed as photocathodes. Upon switching on the light, the MCZO sample exhibited an instantaneous generation of spike current, followed by a rapid decrease in current density, which eventually settled at the dark current value as soon as the light was switched off. The aforementioned cyclic response was repeated for several consecutive cycles, and the same behavior was consistently observed. In contrast, the CZO sample did not show any spike current upon illumination, but rather a gradual increase in current density that reached the steady-state dark current value. The long-term stability of the MCZO photocathode was further investigated. The stability test was conducted by measuring the photocurrent response of the MCZO electrode at a constant applied potential of −0.3 V vs. Ag/AgCl for a duration of 1 hour under continuous illumination. The I-t (current-time) curve obtained for the MCZO sample during the stability test exhibited desirable long-term stability. The photocurrent density remained nearly constant throughout the 1-hour measurement period, demonstrating the robust and reliable performance of the MCZO material as a photocathode.

The significant enhancement in the photocurrent density of the MCZO electrode under illumination suggests that the synergistic effect of Co and Mn co-doping improved the photocatalytic activity and charge separation efficiency compared to the Co-doped CZO electrode. The instantaneous spike current observed in the MCZO sample upon switching on the light may be attributed to the rapid generation of photoinduced charge carriers within the semiconductor material, while the subsequent decrease in current density can be explained by the recombination of photoinduced charge carriers and their trapping at various defect sites. The enhanced current density observed in the MCZO sample compared to CZO may be attributed to the improved charge separation and transport characteristics of the MCZO material, which incorporates both Co and Mn dopants. The sustained photocurrent density in the long-term stability test may be ascribed to the effective charge carrier generation, separation, and extraction processes within the MCZO material, which is likely enhanced by the co-doping of Co and Mn. The stable photocurrent response suggests photocathode potential of the MCZO for practical applications in photoelectrochemical devices, solar fuel generation, and other optoelectronic systems that require long-term operational stability.

The aspects of the present disclosure provide Mn—Co co-doped ZnO (MCZO) nanoparticles, which may be useful as photocatalysts for photoelectrochemical (PEC) water-splitting applications. Incorporating Mn into the ZnO lattice led to a slight shift in the XRD peaks towards higher 20 values, indicative of a reduction in the lattice spacing. Additionally, the XRD peak intensity of the MCZO slightly increased with the addition of Mn, suggesting an enhancement in crystallinity. The average crystallite size decreased from 42.66 nm for undoped ZnO to 40.31 nm for MCZO, which can be attributed to the Zener pinning effect due to the smaller ionic radius of Mn²⁺ compared to Zn²⁺. The FTIR analysis further confirmed the successful doping of Mn and Co into the ZnO lattice, with the observed absorption peaks corresponding to Zn—O, Mn—O, and Co—O stretching modes. Furthermore, the optical and photoluminescence (PL) analyses revealed the significant impact of Mn co-doping on the optoelectronic properties of MCZO. The addition of Mn led to a noticeable enhancement in the light absorption of the MCZO layer, particularly in the visible region, as evidenced by the UV-vis spectroscopy results. The estimated bandgap of MCZO of about 3.61 eV was wider than that of CZO, which was at about 3.39 eV, attributed to the Burstein-Moss effect due to the incorporation of Mn²⁺ ions. The PL spectra showed an increase in the intensity of various defect-related emission peaks, such as those associated with zinc interstitials and oxygen vacancies, upon adding Mn. This observation indicates that Mn doping may introduce additional defect states within the ZnO bandgap, potentially facilitating the separation and transport of photogenerated charge carriers. The photoelectrochemical performance evaluation of the CZO and MCZO electrodes revealed the superior bifunctional catalytic activity of the MCZO material. The MCZO electrode exhibited a substantially higher peak photocurrent density of 2.9×10⁻⁶ A/cm² for the OER, representing a 2.5-fold improvement over the CZO electrode. The transient photocurrent response of MCZO also showed a pronounced spike and higher current generation compared to CZO, indicating improved charge carrier separation and utilization for the desired electrochemical reactions. The EIS measurements further confirmed the enhanced conductivity and lower charge transfer resistance of the MCZO electrode under both dark and illuminated conditions. The superior photoelectrochemical performance of the MCZO electrode may be attributed to the synergistic effect of Mn and Co co-doping, leading to enhanced light absorption, suppressed charge carrier recombination, and improved charge separation efficiency, ultimately resulting in the overall enhanced PEC activity of the MCZO material.

Numerous modifications and variations of the present disclosure are possible in light of the above teachings. It is, therefore, to be understood that within the scope of the appended claims, the invention may be practiced otherwise than as specifically described herein.

1. A photoelectrocatalyst, comprising
nanoparticles of Mn and Co co-doped ZnO having a formula of MnₓCo_{y}Zn_{1-x-y}O, where 0<x≤0.015 and 0<y≤0.025, wherein
the nanoparticles have a band gap of 3.50 to 3.75 eV.

2. The photoelectrocatalyst of claim 1, wherein the nanoparticles have a crystalline wurtzite structure examined by PXRD.

3. The photoelectrocatalyst of claim 1, wherein the nanoparticles have a mean crystallite size of 25 to 60 nm by PXRD.

4. The photoelectrocatalyst of claim 1, wherein the nanoparticles have a flattened hexagonal disc shape having a mean width of 250 to 1750 nm and a mean thickness of 50 to 750 nm.

5. A method of forming the photoelectrocatalyst of claim 1, the method comprising
forming a manganese solution comprising a zinc source and a manganese source;
forming a cobalt solution comprising the zinc source and a cobalt source;
mixing the manganese solution and the cobalt solution to form a metal solution;
adding to the metal solution a base solution comprising a hydroxide base to form a reaction mixture;
hydrothermally treating the reaction mixture at 160 to 200 C for 1 to 8 hours to form an intermediate product; and
annealing the intermediate product at 225 to 325° C. in air to form the photoelectrocatalyst.

6. The method of claim 5, wherein the zinc source is zinc acetate.

7. The method of claim 5, wherein the manganese source is manganese acetate.

8. The method of claim 5, wherein the cobalt source is cobalt nitrate.

9. The method of claim 5, wherein the hydroxide base is sodium hydroxide.

10. The method of claim 5, wherein the hydroxide base is present in the base solution at a concentration of 0.01 to 0.5 M.

11. A method of producing hydrogen gas by a hydrogen evolution reaction, the method comprising:
contacting the photoelectrocatalyst of claim 1 with an aqueous electrolyte solution;
applying a potential of −600 to −50 mV vs Ag/AgCl to the photoelectrocatalyst and a counter electrode immersed in the aqueous electrolyte solution; and
irradiating the photoelectrocatalyst with a light source having an intensity of 10 to 500 mW/cm², wherein
the aqueous electrolyte solution comprises sulfate anions.

12. The method of claim 11, wherein the aqueous electrolyte solution is an aqueous sodium sulfate solution having a sulfate anion concentration of 0.05 to 1.0 M.

13. The method of claim 11, wherein the photoelectrocatalyst has a peak photocurrent density of 6 μA/cm² to 20 μA/cm².

14. The method of claim 11, wherein the photoelectrocatalyst has a photocurrent density of 5 μA/cm² to 7.5 μA/cm² at an applied potential of −100 mV vs Ag/AgCl.

15. The method of claim 11, wherein the photoelectrocatalyst has a ratio of photocurrent density to current density without illumination of 2:1 to 3.5:1 at an applied potential of −300 mV vs Ag/AgCl.

16. A method of producing oxygen gas by an oxygen evolution reaction, the method comprising:
contacting the photoelectrocatalyst of claim 1 with an aqueous electrolyte solution;
applying a potential of 500 to 1100 mV vs Ag/AgCl to the photoelectrocatalyst and a counter electrode immersed in the aqueous electrolyte solution; and
irradiating the photoelectrocatalyst with a light source having an intensity of 10 to 500 mW/cm², wherein
the aqueous electrolyte solution comprises sulfate anions.

17. The method of claim 16, wherein the aqueous electrolyte solution is an aqueous sodium sulfate solution having a sulfate anion concentration of 0.05 to 1.0 M.

18. The method of claim 16 wherein the photoelectrocatalyst has a peak photocurrent density of 1.25 μA/cm² to 4.0 μA/cm².

19. The method of claim 16, wherein the photoelectrocatalyst has a photocurrent density of 0.75 μA/cm² to 1.5 μA/cm² at an applied potential of 800 mV vs Ag/AgCl.

20. The method of claim 16, wherein the photoelectrocatalyst has a ratio of photocurrent density to current density without illumination of 1.5:1 to 4:1 at an applied potential of 800 mV vs Ag/AgCl.
